(19) United States
(12) Patent Application Publication
(10) Pub. No.: US 2006/0282535 A1
(43) Pub. Date: Dec. 14, 2006

(54) Server apparatus

(76) Inventors: Fumikazu Matsukawa, Ome-shi (JP); Shigeru Fukazawa, Hachioji-shi (JP); Yasumasa Sasaki, Tachikawa-shi (JP); Koji Shima, Sagamihara-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/444,575

(22) Filed: May 31, 2006

(30) Foreign Application Priority Data
May 31, 2005 (JP) 2005-160663

(51) Int. Cl. G06F 13/00; G06F 15/173

(52) U.S. Cl. 709/225; 710/33

(57) ABSTRACT

According to one embodiment, a server apparatus includes a memory which stores information indicating permission/non-permission of associations with the data terminals by associating with the telephone IDs, a reader which reads out permission information corresponding to a telephone ID of the first telephone terminal included in information for authentication from the memory, when the information for the authentication including the telephone ID of the first telephone terminal arrived from the first data terminal, to request an association with the first telephone terminal, and a controller which records a user ID of the first data terminal in the management table by associating a user ID of the first data terminal with the telephone ID of the first telephone terminal based on the permission information.

### CROSS-REFERENCE TO RELATED APPLICATIONS

This application is based upon and claims the benefit of priority from Japanese Patent Application No. 2005-160663, filed May 31, 2005, the entire contents of which are incorporated herein by reference.

### BACKGROUND

1. Field

One embodiment of the invention relates to, for instance, a television telephone system, and more specifically, relates to a server apparatus of a visual communication system (VCS) which performs a connection authentication to a client terminal by the server apparatus when a client terminal (data terminal) is associated with an arbitrary telephone terminal.

2. Description of the Related Art

An office and a business institution have used a private network system. This private network system is configured, for example, to house telephone sets in a private branch exchange (PBX) and key telephone apparatus as extension terminals, enable communicating between the extension terminals and an external communication network such as a public network and among extension terminals one another by exchange-connecting through the PBX or button telephone devices. Furthermore, the private network system is configured to connect information terminals such as personal computers to a local area network (LAN) to transmit data among the information terminals with one another via the LAN. A system in which a line switching network using the PBX and key telephone apparatus is connected to the LAN through a gateway apparatus is presented (for instance, Jpn. Pat. Appln. KOKAI. Publication No. 11-355358).

The above-mentioned gateway apparatus supports a plurality of lines (incoming telephone numbers) of the line switching network to assign any one of the lines to each information terminal in a client management table. When an incoming call has arrived at the gateway apparatus from the line switching network, the gateway apparatus notifies an incoming request message to the information terminal which is assigned to the line with the incoming call has arrived thereon.

As mentioned above, although the aforementioned system has examined about an incoming control procedure, etc., between the line switching network and the LAN, the VCS enabling communications by videos in conjunction with operations of the telephone sets by associating the telephone sets with the information terminals on the line switching network has been always extremely desired to be examined. The VCS however has been in examination state still and has not been realized yet.

By the way, the VCS has examined to manage the information terminals and the telephone sets as suites by the server apparatus. Conventionally, however, even a telephone set placed at another place strongly desires to enable making a visual communication. For example, a telephone set placed on user's own desk is desired to make the visual communication at another place such as a conference room, even though the telephone set is associated with the client terminal. In such a case, a user has to move the telephone set itself.

If the user can make the visual communication by the telephone sets placed at a plurality of places, the user probably uses telephone sets owned by other persons, so that effective countermeasures for security are required to be examined.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration diagram showing a visual communication system (VCS) regarding a first embodiment of the present invention;

FIG. 2 is an exemplary block diagram showing a functional configuration of a VCS server in the first embodiment of the present invention;

FIG. 3 is an exemplary view showing an example of a stored content in a log-in management table shown in FIG. 2;

FIG. 4 is an exemplary view showing an example of a stored content in a terminal management table shown in FIG. 2;

FIG. 5 is an exemplary schematic sequence view showing transmission and reception operations of information among telephone terminals, a client terminal and the VCS server in authenticating to execute visual communication control in the first embodiment of the present invention;

FIG. 6 is an exemplary flowchart showing a control procedure of the VCS server in executing authentication control in the first embodiment of the present invention;

FIG. 7 is an exemplary block diagram showing a functional configuration of a VCS server regarding a second embodiment of the present invention; and

FIG. 8 is an exemplary view showing an example of a stored content of a client priority correspondence datable shown in FIG. 7.

### DETAILED DESCRIPTION

Various embodiments according to the invention will be described hereinafter with reference to the accompanying drawings, In general, according to one embodiment of the invention, a server apparatus which receives calling information indicating calling connections of a first and a second telephone terminals among a plurality of telephone terminals from a telephone exchange apparatus to execute exchange processing among the plurality of the telephone terminals to which telephone IDs are assigned, respectively, and which links data communication connections at a first and a second data terminals among the plurality of the data terminals with the calling connections based on a management table with user IDs assigned to the plurality of the data terminals, respectively, by associating with the telephone IDs, the server apparatus comprising: a memory which stores information indicating permission/non-permission of associations with the data terminals by associating with the telephone IDs; a reader which reads out permission information corresponding to a telephone ID of the first telephone terminal included in information for authentication from the memory, when the information for the authentication including the telephone ID of the first telephone terminal arrived from the first data terminal, to request an association with the first telephone terminal; and a controller which records a user ID of the first data terminal in the management table by associating a user ID of the first data terminal with the telephone ID of the first telephone terminal based on the permission information.

### First Embodiment

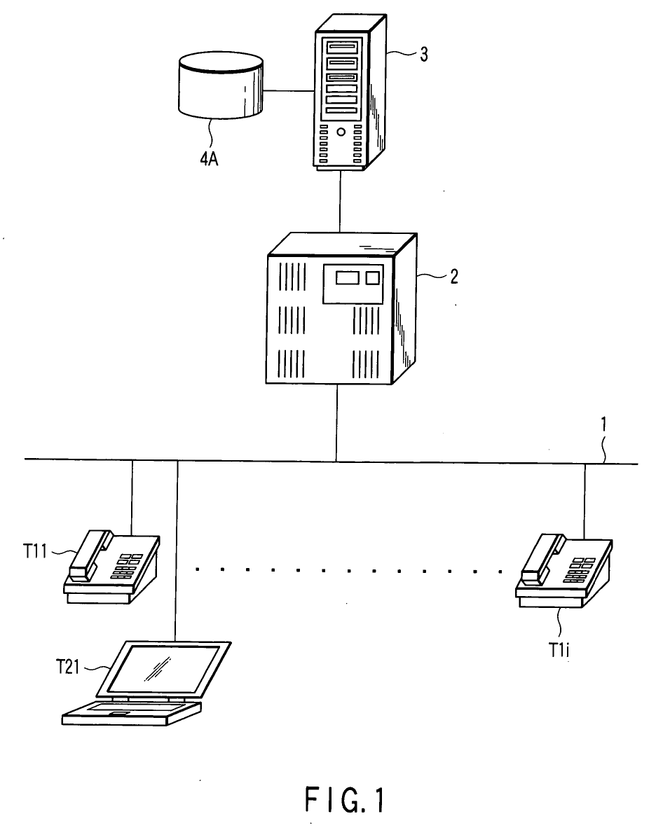

FIG. 1 is the exemplary schematic diagram showing the visual communication system (VCS) regarding the first embodiment of the present invention.

The system has a communication line 1 as shown in FIG. 1. A plurality of telephone terminals T11 to T1i (i is natural number) are connected to the communication line 1. The telephone terminals T11 to T1i include mobile telephone sets, mobile information terminals equipped with voice communication functions and wireless LAN access functions, respectively, other than IP telephone sets equipped with communication processing functions and media information processing functions, respectively.

A main apparatus 2 is connected to the communication line 1. The main terminal 2 connects a plurality of telephone terminals T11 to T1i, connected to the communication line 1, with one another and between the plurality of telephone terminals T11 to T1i and a public network (not shown).

A VCS server 3 is connected to the main apparatus 2. The VCS server 3 executes a part of functions of the main apparatus 2, and, for instance, when a client terminal 21 as a data terminal is connected to the communication line 1, the VCS server 3 performs visual communication control by associating the telephone terminal T11 with the client terminal T21. At this time, the VCS server 3 authenticates the client terminal T21 by using a user ID and a password stored in a storage device 4A in advance. As for the client terminal T21, a general-purpose personal computer is used.

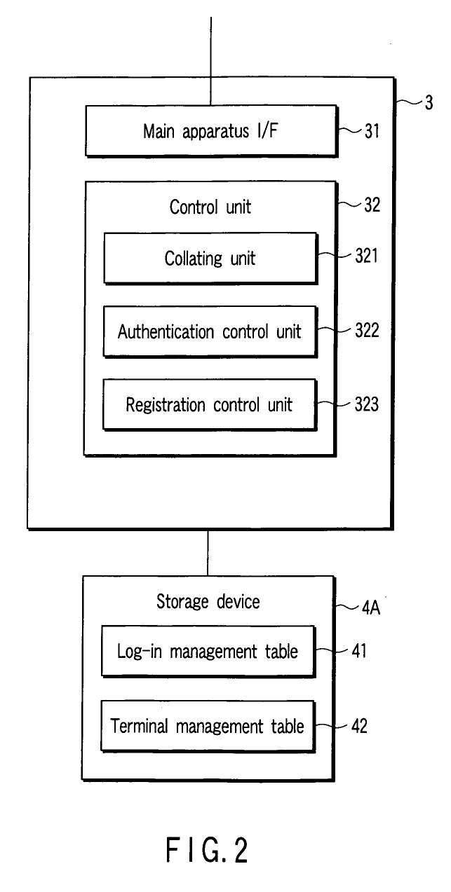

FIG. 2 is a block diagram showing a functional configuration of the VCS server 3.

The VCS server 3 has a main apparatus interface (I/F) unit 31 and a control unit 32. The I/F unit 31 performs interface processing to the main apparatus 2.

The control unit 32 has a collating unit 321, an authentication control unit 322 and a registration control unit 323 as new functions added to the present invention in addition to an authentication function to the client terminal T21 and a control function regarding coordinated operations among telephone terminals T11 to T1i and the client terminal T21.

The storage device 4A has a log-in management table 41 and a terminal management table 42 in addition to a data base with the user ID and the password stored therein.

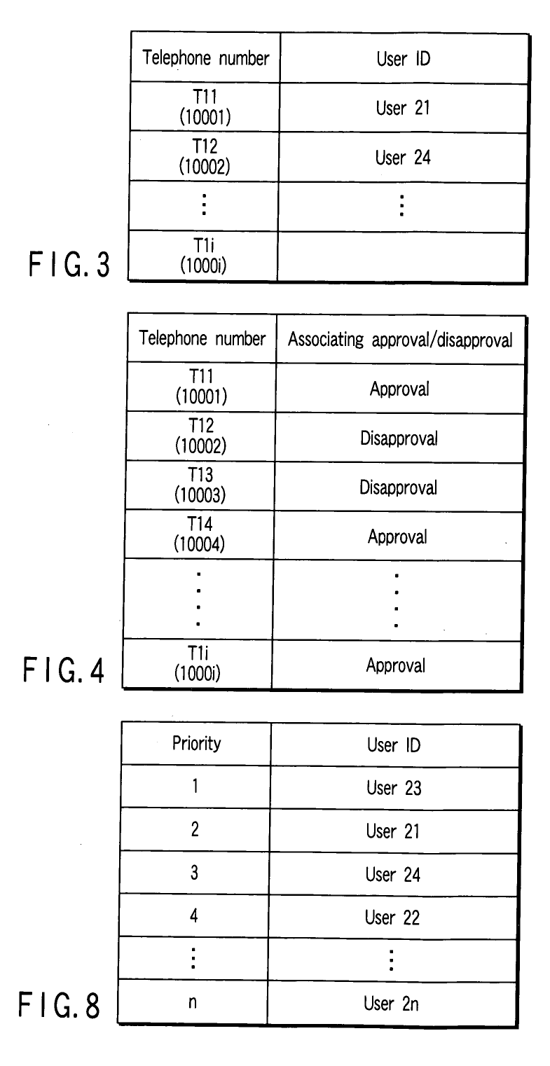

The log-in management table 41 stores, as shown in FIG. 3, data indicating correspondence relationships among the telephone numbers as each telephone ID of the telephone terminals T11 to T1i and the user IDs assigned to each client terminal 21, respectively.

The terminal management table 42 stores, as shown in FIG. 4, data indicating correspondence relationships among each telephone number of the telephone terminals T11 to T1i and information showing propriety of association with the client terminal T21.

The collating unit 321 collates a telephone number ‘10001’ of the telephone terminal T11 included in a log-in request and telephone number ‘10001’ of the telephone terminal T11 in the management table 42 with the information showing the propriety of the association when the log-in request has reached from the client terminal 21.

The authentication control unit 322 authenticates the client terminal T21 if the association with the telephone terminal T11 has its priority as the collating result from the collating unit 321 to execute the visual communication control in conjunction between the client terminal T21 and the selected telephone terminal T11.

In contrast, if the association has no priority, or another user ID is registered in the management table 41 in association with the telephone terminal T11, the authentication control unit 322 notifies an error message to the client terminal T21. If the same user ID is registered in the management table 41 in association with the telephone terminal T11, the authentication control unit 322 inquires whether the user ID in the management table 41 should be updated or not to the client terminal T11 that is a request origin. And if the user of the client terminal T21 inputs an update instruction in response to the inquiry, the authentication control unit 322 updates the corresponding user ID in the management table 41.

If the authentication control unit 322 has authenticated to the client terminal 21, the registration control unit 323 registers the user ID (user 21) assigned to the client terminal 21 in association with the telephone number of the selected telephone terminal T11 in the management table 41.

Next to this, operations of the VCS configured as described above will be explained.

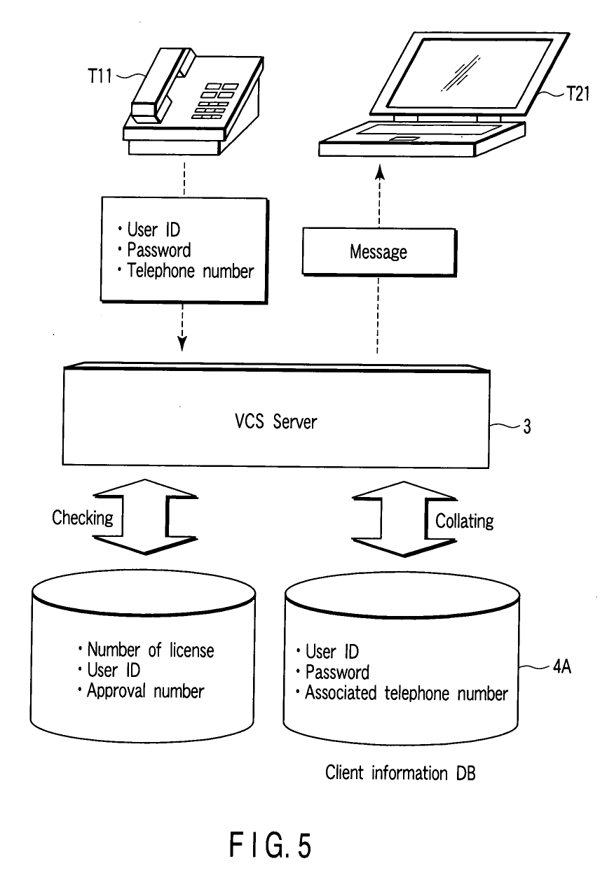

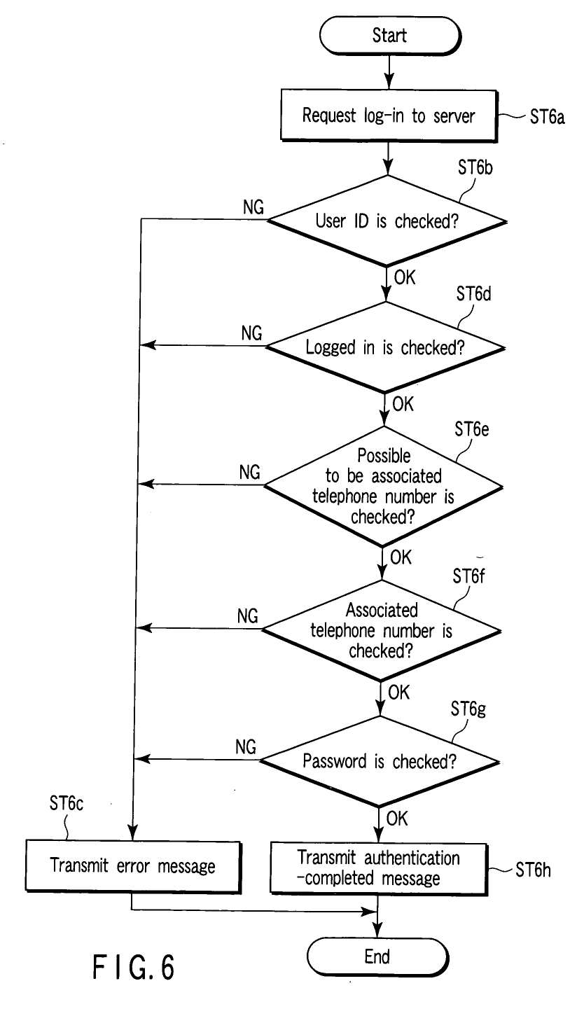

FIG. 5 is a schematic sequence view showing transmission and reception operations of the information among the telephone terminal T11, the client terminal T21 and the VCS server 3 in authenticating to execute visual communication control. FIG. 6 is a flowchart showing the control procedure of the VCS server 3 in executing the authentication control.

When executing a visual communication, the user of the client terminal 21 accesses to the VCS server 3 so as to associate the client terminal 21 with the telephone terminal T11.

The user of the client terminal T21 then inputs, on a log-in screen, the telephone number ‘10001’ of the telephone terminal T11 intended to be associated with the user ID, the password and the client terminal T21 to try logging in to the VCS server 3. After completing the inputs, the client terminal T21 transmits the user ID, the password and the telephone number toward the VCS server 3.

When receiving the log-in request from the client terminal T21, the VCS server 3 checks whether the number of logged in users excesses the prescribed number of licenses by firstly logging in by the user of the client terminal 21. If the number of the logged in users possibly excesses the prescribed number, the VCS server 3 does not allow logging in to reply an error message notifying a log-in excess to the client terminal T21.

In contrast, if the license check has been cleared, the VCS server 3 makes a shift from a block ST6a to a block ST6b then checks whether the user ID coincides with any one user ID in a user ID group registered in the storage device 4A in advance. If there is no user ID coinciding with the user ID in the user ID group, the VCS server 3 does not allow the log-in by the client terminal T21 then shifts from the block ST6b to a block ST6c to reply therefrom the fact of the absence of a user's name as the error message to the client terminal T21.

To prevent double log-in by the same user ID, the VCS server 3 does not allow new log-in if any user has already logged in by the user ID even if the user ID which has input from the client terminal T21 ID coincides with the registered user ID. And the VCS server 3 makes a shift from a block ST6d to the block ST6c to reply, from here, the fact that the terminal T21 has already logged in, as the error message, to the client terminal T21.

When passing the user ID check, the VCS server 3 shifts from the block ST6d to the block ST6c then checks whether or not the telephone number requested associations coincide with any telephone number in a permitted telephone number group stored in the terminal management table 42. And if the telephone number does not coincide with any telephone number, the VCS server 3 shifts from the block ST6e to the block ST6c then replies an error message notifying the impossibility of the associations of the telephone number.

Since the VCS server 3 does not allow double associations of the same telephone numbers even if the associations are possible, the VCS server 3 does not newly associate the telephone number with other telephone numbers if the telephone number has been associated by another user. The VCS server 3 then shifts from a block ST6f to the block ST6c to replay, from here, an error message notifying the fact that the telephone number has been in use to the client terminal T21.

In contrast, if the check for the telephone number has been also cleared, the VCS server 3 makes a shift from the block ST6f to a block ST6g to authenticate a password (perform digest authentication of SIP) therein. Here, if the password is not correct, the VCS server 3 shifts from the block ST6g to the block ST6c to reply the fact of incorrectness as an error message to the client terminal T21 terefrom.

On the contrary, if all the checks have been cleared, the VCS server 3 makes a shift from the block ST6g to a block ST6h to reply a message of the completion of the authentication to the client terminal T21 therefrom and registers the user of the client terminal T21 as a user during logging in to the log-in management table 41.

Consequently, for example, when the telephone terminal T11 and the telephone terminal T15 are connected with each other, visual communications among client terminals associated with each telephone terminal T11 and T15 are automatically started, and when communications are completed, the visual communications are also automatically completed. The VCS server 3 also operates in response to holding and transfer during communications.

In the first embodiment, as mentioned above, the VCS server 3 determines the priority of the association between the selected telephone terminal T11 and the client terminal T21 by using information about the priority of the association between the client terminal T21 with the telephone terminals T11 to T1i stored and managed in and by the terminal management table 42 other than the user IDs and the passwords registered in the storage device 4A.

Accordingly, appropriate authentication processing can be performed in a simple procedure to the client terminal T21 connected to the selected telephone terminal T11. And the telephone terminal T14, if it is one possible to be authenticated even at other places, the telephone terminal T14 can execute visual communications, thereby, usability of the user is extremely improved. Furthermore, with non-permission information of use stored in the management table 42 by associating the information with the telephone number of the telephone terminal T12, the telephone terminal T12 not expected to be used by other users can prevent other users from using it improperly.

In the first embodiment, the VCS server 3 determines the priority of the association between the selected telephone terminal T11 and the client terminal T21 by using permission/non-permission information of associations for telephone terminals T11 to T1i with the client terminal T21 stored and managed in and by the terminal management table 42, and also by using the user ID registered in the log-in management table 41. Accordingly, if other users deliberately intend to authenticate by plagiarizing the telephone number of the telephone terminal T11, the VCS server 3 can prevent the telephone terminal T11 from being used improperly.

Furthermore, in the first embodiment, when the selected telephone terminal T11 has been already been in use, since the fact is notified to the client terminal T21, the user itself of the client terminal T21 can determine whether the telephone terminal T11 should be used or not to instruct the use thereof.

### Second Embodiment

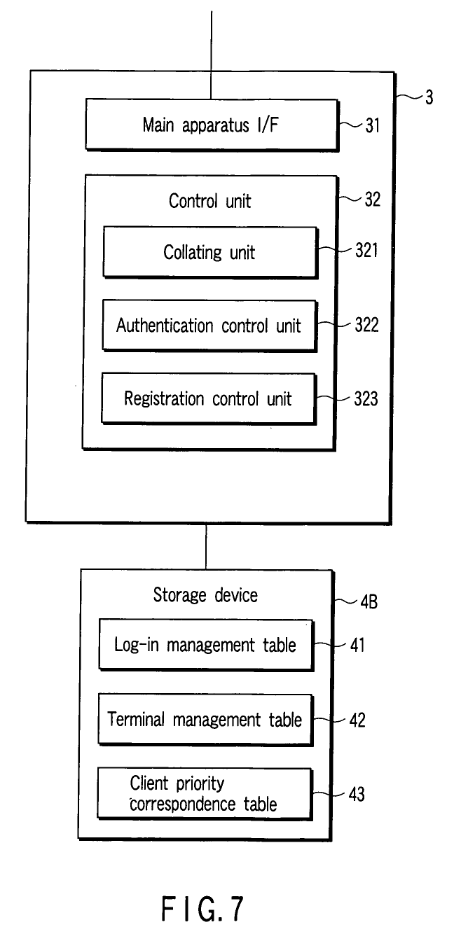

FIG. 7 is the block diagram showing the functional configuration of the VCS server 3 regarding the second embodiment of the present invention. In FIG. 7, the same functions as those of FIG. 2 will be put the same symbols and those detailed description will be omitted.

That is to say, a storage device 4B is provided with a client-priority correspondence table 43. The correspondence table 43 stores, as shown in FIG. 8, data indicating correspondence relationships between the priorities and the user IDs assigned to each client terminal T21, respectively.

The authentication control unit 322 refers to the correspondence table 43 when the telephone terminal T11 with the client terminal T21 (user ID=user 21) of the log-in request origin is possible to be associated and also a user 22 is registered in association with the telephone terminal T11 in the log-in management table 41. And then, the authentication control unit 322 compares the priority of the user 22 to that of the user 21, and the priority of the user 21 is higher in this case, so that it associates the client terminal T21 with the telephone terminal T11.

In contrast, if a user 23 is registered in association with the telephone terminal T11 in the log-in management table 41, the authentication control unit 322 transmits an error message indicating the fact of being in use of the telephone terminal T11 to the client terminal T21.

As described above, the shared use of one telephone terminal T11 by a plurality of users makes the VCS in the second embodiment possible to relatively flexibly respond in accordance with the priorities of each user ID, thereby, fine and each processing for every user can be achieved.

### Other Embodiments

The present invention is not limited to each of the aforementioned embodiments. Each embodiment, for instance, the users of the client terminals input the telephone numbers associated with the user IDs and the passwords. However, it is not limited in this case; a VCS server may have a function to notify a plurality of telephone numbers corresponding to permission information stored in a terminal management table in accordance with the instruction from a client terminal. Such a configuration enables the user of the client terminal to generate log-in information only by specifying and inputting any one of presented plurality of telephone numbers. The user thereby can simplify authentication request operations and also can decrease erroneous setting. And the user can accurately determine in advance whether or not the selected telephone terminal is possible to be associated with the client terminal.

In each embodiment described above, having mentioned an example in which a user of a client terminal selects a telephone terminal. However, it is not limited to these embodiments, and a client terminal connectable to a mobile telephone set may be selected and specified, for instance, when telephone terminals are mobile telephone sets.

In the first embodiment, having described the example in which the data indicating the correspondence relationships to the permission/non-permission information of the association of the telephone terminals with the telephone numbers in the terminal management table; however, it is not limited to this configuration, the terminal management table may store only the telephone numbers possible to be associated with the client terminal.

Other than this, even the configurations and types of the VCS server, types of telephone exchange apparatus (may be PBX not limited to main apparatus), types of the client terminal, storage contents of a variety of tables, authentication control methods, or the like can be implemented in a variety of modifications without departing from the sprit or scope of the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalent are intended to cover such forms or modifications as would fall within the scope and spirit of the invention.

What is claimed is:

1. A server apparatus which receives calling information indicating calling connections of a first and a second telephone terminals among a plurality of telephone terminals from a telephone exchange apparatus to execute exchange processing among the plurality of the telephone terminals to which telephone IDs are assigned, respectively, and which links data communication connections at a first and a second data terminals among the plurality of the data terminals with the calling connections based on a management table with user IDs assigned to the plurality of the data terminals, respectively, by associating with the telephone IDs, the server apparatus comprising:
a memory which stores information indicating permission/non-permission of associations with the data terminals by associating with the telephone IDs;
a reader which reads out permission information corresponding to a telephone ID of the first telephone terminal included in information for authentication from the memory, when the information for the authentication including the telephone ID of the first telephone terminal arrived from the first data terminal, to request an association with the first telephone terminal; and
a controller which records a user ID of the first data terminal in the management table by associating a user ID of the first data terminal with the telephone ID of the first telephone terminal based on the permission information.

2. The server apparatus according to claim 1, wherein the controller notifies the fact that authentication is not permitted to the first data terminal when the permission information indicates non-permission.

3. The server apparatus according to claim 1, wherein the controller notifies the fact that authentication is not permitted to the first data terminal when the permission information indicates permission and also when the user IDs are recorded in the management table by associating with the first telephone terminal.

4. The server apparatus according to claim 1, wherein the controller inquires whether association with telephone IDs in the management table should be updated or not to the first data terminal when the user IDs are recorded in the management table by associating with the first telephone terminal and also when the corresponding user ID and the user ID of the first data terminal are the same as each other.

5. The server apparatus according to claim 1, further comprising:
a notifying unit to notify a plurality of telephone IDs corresponding to the permission information stored in the memory to the first data in accordance with an instruction from the first data terminal before receiving the information for the permission from the first data terminal.

6. The server apparatus according to claim 1, further comprising:
a priority information memory which stores each user ID of the plurality of the data terminals by associating with priority information, wherein
the controller records a user ID of the first data terminal by associating with the telephone ID of the first telephone terminal based on priority information corresponding to the user ID of the first data terminal, when the permission information indicates permission and also when the user IDs are recorded in the management table by associating with the first telephone terminal.

7. The server apparatus according to claim 1, further comprising:
a receiver which receives information for permission including the telephone ID of the first telephone terminal and a user ID of a third data terminal differing from the first data terminal from the first telephone terminal.
